(19) United States
(12) Patent Application Publication
(10) Pub. No.: US 2023/0234436 A1
(43) Pub. Date: Jul. 27, 2023

(54) AIR FLOW REGULATING DEVICE OF A MOTOR VEHICLE

(71) Applicant: VALEO SYSTEMES THERMIQUES, La Verriere (FR)

(72) Inventors: Enzo MITIDIERI, La Verriere (FR); Sylvain GERBER, La Verriere (FR); Simon TIERCE, La Verriere (FR)

(73) Assignee: VALEO SYSTEMES THERMIQUES, La Verriere (FR)

(21) Appl. No.: 17/918,954

(22) PCT Filed: Apr. 19, 2021
(86) PCT No.: PCT/EP2021/060138

§ 371 Date: Oct. 14, 2022

(30) Foreign Application Priority Data
Apr. 20, 2020 (FR) FR2003942

(51) Int. Cl. B60K 11/08

(52) U.S. Cl. CPC B60K 11/085

(57) ABSTRACT

The invention relates to a device for regulating an air flow intended to circulate through a heat exchanger for a motor vehicle, the device including at least one shutter capable of moving in an opening and closing direction between a closed position preventing the passage of the air flow and an open position allowing the passage of the air flow, the shutter being arranged to wind and unwind around a winding shaft, the device including a kinematic assembly for moving the shutter in the closing and opening direction, said kinematic assembly having at least one portion of the shutter.

### CROSS-REFERENCE TO RELATED APPLICATIONS

This application is filed under 35 U.S.C. § U.S. National Phase of International Application No. PCT/EP2021/060138 filed Apr. 19, 2021 (published as WO2021214001), which claims priority benefit to French Application No. 2003942 filed on Apr. 20, 2020, the disclosures of which are herein incorporated by reference in their entirety.

### TECHNICAL FIELD

The invention relates to a device for regulating an air flow circulating in a heat exchanger for a motor vehicle and to a cooling module provided with such a device. It is intended in particular for being provided in a motor vehicle front end.

### BACKGROUND OF THE INVENTION

It is known practice to use shutters controlled by an actuator in a vehicle front end in order to reduce the drag coefficient and also to improve cooling and air conditioning performance. Such a system is usually denoted by the acronym AGS, from the expression “Active Grille Shutter”. The AGS is preferably installed on a motor vehicle grille. In the open position of the air inlet, the air can flow through the grille and contribute in particular to cooling the engine of the motor vehicle. In the closed position of the air inlet, the air does not enter via the grille, which reduces drag and thus makes it possible to reduce fuel consumption and carbon dioxide emissions. The AGS therefore makes it possible to reduce energy consumption and pollution when the engine does not need to be cooled by the exterior air.

In some cases, it is not possible to position an AGS on the grille, in front of the exchangers, due to an unsuitable environment, the client's wishes, or other reasons.

Motor vehicle cooling modules comprising two heat exchangers are known. A first heat exchanger has the function of cooling an auxiliary circuit of the vehicle, such as an air conditioning device or charge air cooling device. A second heat exchanger is needed for cooling the engine of the vehicle. These heat exchangers are positioned in the front end of the vehicle, assembled and aligned in series so that the air flow entering through the vehicle grille passes through them in succession. They typically comprise a heat exchange bundle comprising tubes in which the fluid to be cooled circulates and through which the air coming from the grille passes.

In order to separate the cooling of the two heat exchangers and optimize the aerodynamic performance of each heat exchanger, the applicant has recently proposed a device for regulating the air flow intended to circulate in heat exchangers, in an unpublished patent application by the applicant. The regulating device comprises two curtains mounted in a frame and able to be moved alternately in translation between two positions: open and closed. By moving between these two positions, the curtains allow the regulating device to alternately allow through or obstruct the air flow passing through the grille of the motor vehicle. The curtains are moved by means of a transmission system that guides the movement of said curtains in translation, and an actuator causing the transmission system to move.

### BRIEF SUMMARY OF THE INVENTION

The invention relates to a device for regulating an air flow intended to circulate through a heat exchanger for a motor vehicle, the device comprising at least one curtain able to move in an opening and closing direction, between a closed position obstructing the passage of the air flow and an open position allowing through the air flow (F), the curtain being arranged to wind and unwind around a winding shaft, the device including a kinematic assembly arranged to set the curtain in motion in the opening and closing direction, said kinematic assembly including at least one portion of the curtain.

The invention makes it possible to simplify the air flow regulating device because, as the curtain plays a role in the kinematic assembly, the number of parts can be reduced, for example by avoiding the use of independent belts for the curtains, and the associated pulleys.

The invention can also make it possible to reduce wear in general, as the curtain(s) play a kinematic role, which prevents wear on other parts.

In addition, the invention makes possible direct drive of the different parts of the device, namely the winding shafts and the curtain(s) in particular.

According to one aspect of the invention, this curtain portion is the entire curtain.

According to one aspect of the invention, the device includes two winding shafts, in particular positioned at two longitudinal ends of an air passage, and the curtain is arranged so that it can wind around at least one of these shafts, the kinematic assembly interacting with the two shafts.

According to one aspect of the invention, the device includes an electric actuator interacting with one of the winding shafts in order to rotate it, and the kinematic assembly is arranged to be set in motion by this winding shaft, which is capable of being driven by the electric actuator.

According to one aspect of the invention, the kinematic assembly is arranged to transmit a movement of the winding shaft associated with the electric actuator to the other winding shaft, said kinematic assembly thus interacting with the two shafts in order to associate the respective rotation thereof.

According to one aspect of the invention, one of the winding shafts can be driven by the electric actuator and the other winding shaft is passive, being driven by the kinematic assembly, which transmits the movement of the shaft associated with the actuator to the other shaft.

According to one aspect of the invention, the curtain is extended by a belt element that forms part of the kinematic assembly.

According to one aspect of the invention, the belt element is integrally formed with the curtain, that is, the curtain and said belt element are made in one piece, said piece being in particular a piece of cloth.

According to one aspect of the invention, this piece is obtained by cutting.

If two curtains are used to open and close the air flow, the invention makes it possible to have two identical curtains, which makes it possible in particular to simplify the manufacturing of the device. In addition, cutting the identically shaped pieces of cloth out of a larger piece of cloth makes it possible to substantially reduce cloth offcuts and therefore limit waste.

The belt element that extends the curtain forms a complete belt with at least the curtain portion, connecting the two winding shafts for conjoint movement. In other words, the curtain itself or at least one portion of this curtain plays a role in the transmission of movement from one winding shaft to the other. The curtain or a portion thereof is an element of the movement transmission chain between the two winding shafts. Without the curtain, movement could not be transmitted between the two shafts. There is thus no other belt independent of the curtain(s).

According to one aspect of the invention, said piece of cloth is made from a flexible material, in particular a glass fiber-based cloth, preferably covered with an impermeable, water-repellent coating.

According to one aspect of the invention, the curtain is extended by two belt elements, on opposite edges of the curtain, said belt elements forming part of the kinematic chain.

According to one aspect of the invention, said belt elements are symmetrical to each other about a line of symmetry passing through the middle of the curtain.

According to one aspect of the invention, the belt element has an elongate shape.

According to one aspect of the invention, the belt element is substantially the same length as the curtain measured along the closing and opening direction of the curtain.

According to one aspect of the invention, the curtain is extended by a belt element, which in particular takes the form of a strip of material, and the curtain has lower and upper edges, in particular parallel to the opening and closing direction of the curtain, the belt element extending parallel to said edges of the curtain.

According to one aspect of the invention, one of the belt elements extends at least partially above the upper edge of the curtain and the other belt element extends at least partially below the lower edge of the curtain.

In other words, for example, when the curtain and the belt elements are laid flat, the belt elements, in particular formed from strips of material, move away from the upper and lower edges of the curtain. The belt elements thus do not obstruct the air flow passage when the curtain is open, and are away from the location occupied by the curtain in the closed position.

According to one aspect of the invention, the device includes two identical curtains, each with a pair of belt elements positioned parallel to the lower and upper edges of the curtain.

According to one aspect of the invention, the curtain includes a leading border, in particular straight, perpendicular to the opening and closing direction of the curtain, the upper and lower edges being in particular perpendicular to the leading border.

According to one aspect of the invention, the belt elements are connected to the curtain in line with the leading border.

According to one aspect of the invention, the leading border is rigidly connected to a sealing member, in particular in the form of a rod assembled with a seal, this rod being in particular arranged to hold the belt elements.

According to one aspect of the invention, the seal, which has for example a sealing lip, is fastened to said rod.

According to one aspect of the invention, the sealing lips associated with the two curtains come into contact with each other when the curtains are in the closed position, so that they prevent the air flow from passing through.

If two opposite curtains are provided, each curtain is in particular wound on a winding shaft and the belt elements associated with said curtain wind on the other winding shaft.

On each winding shaft, the curtain that winds on it occupies in particular the majority of the height of said shaft and, at the ends of the shaft, outside this portion occupied by the curtain, are two zones for fastening the belt elements of the other curtain, which curtain is wound on the opposite winding shaft.

According to one aspect of the invention, the end of each belt element is fastened to a core, in particular made from plastic, said core forming part of the winding shaft.

According to one aspect of the invention, the belt elements form straps that extend the curtain. The curtain portion that forms part of the kinematic assembly is thus the entire curtain.

According to one aspect of the invention, at least one of the winding shafts, in particular the one that is not directly driven by the electric actuator, is rigidly connected to a tensioning unit comprising an elastic member, in particular a spring, arranged to move the winding shaft over a sufficient translation amplitude to keep the curtain(s) tensioned.

According to one aspect of the invention, said tensioning unit includes a fastening element provided with an orifice through which a protrusion, in particular a spur, of the winding shaft can pass in order to rigidly connect said shaft and the tensioning unit for conjoint translation, and said unit includes a spring pressing against a fixed wall of the device so that the tensioning unit can move relative to the fixed wall against the elastic force of the spring, so that the spacing between the two winding shafts can vary and maintain sufficient tension in the curtain(s).

According to one aspect of the invention, the winding shaft includes two assembled longitudinal portions around which the curtain winds.

When two curtains are provided, they extend in particular, in the closed position, substantially in two parallel planes, spaced apart from each other by a certain distance, in particular less than 5 mm, or 1 mm.

When a single curtain is provided for closing the air passage, the belt elements are in particular substantially twice the length of the curtain, these dimensions being measured along the closing and opening direction of the curtains.

According to one aspect of the invention, the belt elements are elements assembled with the associated curtain, that is, the belt element is not integrally formed with the curtain.

According to one aspect of the invention, the belt element is made from a different material from the curtain.

Of course, the upper and lower edges of the curtain can be vertical right and left edges if the curtain(s) is/are used in vertical movement, with the closing direction oriented vertically instead of horizontally.

The invention also relates to a device for regulating an air flow intended to circulate through a heat exchanger for a motor vehicle, the device comprising at least one curtain able to move in an opening and closing direction, between a closed position obstructing the passage of the air flow and an open position allowing through the air flow (F), the curtain being arranged to wind and unwind around a winding shaft, at least one of the winding shafts, in particular the one that is not directly driven by an electric actuator, being rigidly connected to a tensioning unit including an elastic member, in particular a spring, arranged to move the winding shaft over a sufficient translation amplitude to keep the curtain(s) tensioned.

### BRIEF DESCRIPTION OF THE DRAWINGS

It will be understood that the features and configurations above are in no way limiting. Further features, details and advantages of the invention will become apparent from the following detailed description and from several exemplary embodiments given as non-limiting examples with reference to the attached schematic drawings, in which:

FIG. 1 is a schematic side view of the front end of a vehicle comprising a cooling module provided with a regulating device according to the invention;

FIG. 2 is a schematic front view of a regulating device according to the invention, with the curtains in the open position;

FIG. 3 is a schematic front view of a regulating device according to the invention, with the curtains in the closed position;

FIG. 4 is a schematic illustration of another regulating device of the invention;

FIG. 5 is a schematic illustration of the elements of the device in FIG. 4;

FIG. 6 is a schematic illustration of a device according to another exemplary embodiment of the invention, in the closed position;

FIG. 7 is a schematic illustration of a device according to the preceding figure, in the open position;

FIG. 8 is an enlarged schematic illustration of the device according to FIG. 6, in the closed position;

FIG. 9 is a view of another exemplary embodiment of the invention;

FIG. 10 is a view of a detail of the exemplary embodiment in FIG. 9;

FIG. 11 is a view of another detail of the exemplary embodiment in FIG. 9;

FIG. 12 is an exploded view of a device according to another exemplary embodiment of the invention;

FIG. 13 is a view of the device in FIG. 12, in the closed position;

FIG. 14 is a view of the device in FIG. 12, in the partially open position;

FIG. 15 is a view of the device in FIG. 12, in the fully open position; and

FIG. 16 is a top view of the device in FIG. 12.

### DETAILED DESCRIPTION OF THE INVENTION

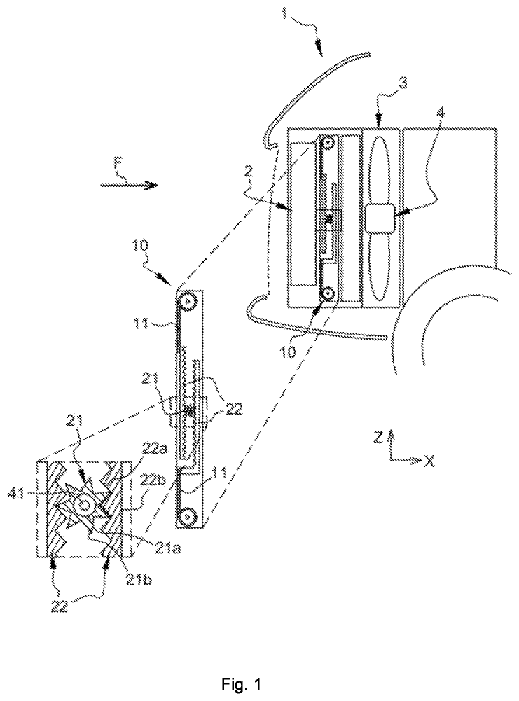

FIG. 1 is a side view of a device 10 for regulating an air flow F, and a cooling module 1, both according to the invention. The cooling module 1 extends depth wise in a direction X intended to correspond to the longitudinal axis of the equipped vehicle. The air flow F is substantially parallel to the direction X. The cooling module 1 is configured to be fixed to a support, such as a chassis of the vehicle.

The cooling module 1 comprises an upstream heat exchanger 2 (situated on the left in FIG. 1) and a downstream heat exchanger 3 (situated on the right in FIG. 1), arranged in series in the direction of flow of the air flow F passing through them. In other words, the cooling module 1 is configured to be positioned on its support in such a way that the air flow F passes through the upstream heat exchanger 2 first, and the downstream heat exchanger 3 second.

The upstream heat exchanger 2 is a cooling radiator, referred to as a low temperature radiator, used to cool a coolant of a heat exchange loop, referred to as a low-temperature loop, comprising in particular an air conditioning condenser and/or a charge air cooler. The downstream heat exchanger 3 is, for example, a high-temperature cooling radiator intended to cool a coolant of a heat exchange loop comprising an engine of the vehicle. The air that passes through this downstream exchanger 3 cools the engine coolant.

Each heat exchanger 2, 3 comprises for example a heat exchange bundle and header chambers positioned laterally on either side of the bundle (not illustrated). The air flow F passes through the bundle. It comprises a set of mutually parallel tubes opening into the header chambers, for the circulation of the coolant (not illustrated).

The cooling module 1 is advantageously configured to allow a substantially fluid-tight air flow between said heat exchangers 2, 3, that is, the upstream heat exchanger 2 and the downstream heat exchanger 3 are assembled with one another in such a way that air coming from outside the cooling module 1 does not pass directly through the downstream heat exchanger 3. In other words, the air flow F passing through the downstream heat exchanger 3 comes from the air flow passing through the upstream heat exchanger 2. To this end, the cooling module 1 can for example comprise sealing components guiding all of the air flow that has passed through the upstream heat exchanger 2 to the downstream heat exchanger 3 without a loss of air flow rate. These sealing components, not illustrated, can for example comprise a duct arranged between the two heat exchangers 2, 3.

To facilitate the passage of the air flow through the cooling module 1, in particular when the vehicle is stationary, the cooling module 1 advantageously comprises a motor-fan unit 4 able to cause the air to circulate in the cooling module 1. As illustrated in FIG. 1, here the motor-fan unit 4 is positioned downstream of the downstream exchanger 3, the motor-fan unit 4 being configured to draw air from an air inlet of the vehicle, which is preferably defined by the grille thereof.

The cooling module 1 according to the invention further comprises a device 10 for regulating the air flow preferably arranged between the upstream heat exchanger 2 and the downstream heat exchanger 3. The device 10 has a small thickness in the depth of the cooling module 1. The device 10 controls the passage of the air flow F from the upstream heat exchanger 2 to the downstream heat exchanger 3 by means of blinds or curtains 11 that can be wound/unwound.

As a variant, the cooling module 1 according to the invention can comprise a single heat exchanger, for example a cooling radiator, said device 10 then being arranged upstream or downstream of said heat exchanger. In such a configuration, the air flow F passing through the heat exchanger comes from the air flow F passing through the device 10 or opens into said device 10.

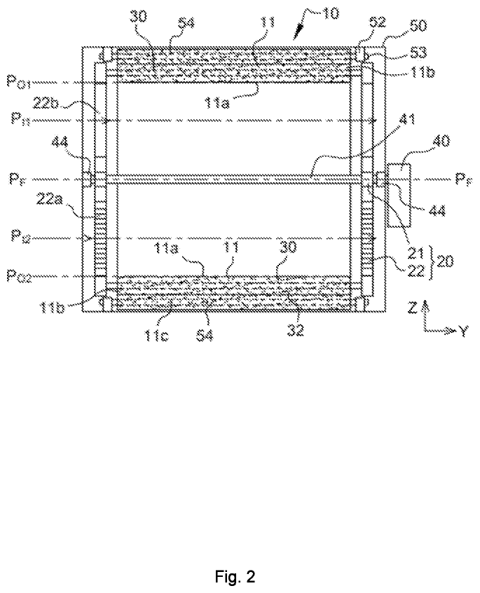

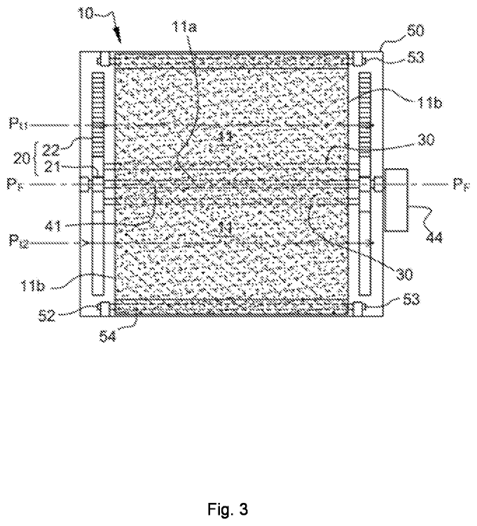

With reference to FIGS. 2 and 3, the device 10 according to a first embodiment of the invention is illustrated in a schematic front view. The device 10 comprises two generally rectangular curtains 11. Each curtain 11 is delimited by a proximal border 11a, two lateral borders 11b, and a distal border 11c. Said lateral borders 11b are opposite and substantially parallel to a direction Z, orthogonal to the direction X, while said proximal border 11a and said distal border 11c are opposite and substantially parallel to a direction Y, orthogonal to the directions X and Z, the direction Z here representing the vertical.

In FIG. 2, the device 10 is in the open position PO, that is, the curtains 11 allow the air flow F through. In this configuration, the proximal borders 11a of said curtains 11 are apart from one another. More specifically, a first proximal border 11a is situated in the vicinity of an upper beam of a frame 50 of the device 10, in particular level with a first open position PO1, while a second proximal border 11a is situated in the vicinity of a lower beam of the frame 50, in particular level with a second open position PO2, opposite to PO1 relative to an axis passing through a dashed line PF-PF.

The device 10 further comprises winding shafts 53 for winding/unwinding the curtains 11, which are connected to the frame 50 by articulating bearings 52.

Preferably, each curtain 11 is kept taut by tensioning components 54 connected to its distal border 11c. The tensioning components 54 exert a force on the curtains 11 so that said curtains 11 are continuously kept taut. For example, the tensioning components 54 can be springs, in particular spiral springs, or any other components that make it possible to keep said curtains 11 taut. Preferably, each tensioning component 54 is connected to the frame 50 and to the winding shaft 53.

In FIG. 3, the device 10 is in the closed position PF. The curtains 11 extend in a plane, referred to as the plane of extension of the curtains 11 in the closed position. Said plane of extension of the curtains 11 in the closed position is oriented in the direction Z, corresponding to the direction of opening/closing of the curtains 11, and in the direction Y. In other words, said plane of extension of the curtains 11 in the closed position extends transversely to the air flow F. In this configuration, the respective proximal borders 11a of the curtains 11 are in contact with one another level with the dashed line PF-PF. The curtains 11 therefore obstruct the passage of the air flow F, which circulates perpendicular to the plane of extension of the curtains 11 in the closed position.

The device 10 is configured so that said curtains 11 are able to move in the direction of opening/closing Z, in said plane of extension of the curtains 11 in the closed position. In other words, the device 10 can alternately adopt the configurations illustrated in FIGS. 2 and 3. To this end, the device 10 comprises a transmission system 20 and at least two drive members 30 connected to said transmission system 20.

The features and operating principle of the transmission system 20 are described below.

The transmission system 20 comprises pinions 21. As can be seen more clearly in FIG. 1, said pinions 21 comprise a peripheral border 21a and teeth 21b situated on said peripheral border 21a. The pinions 21 are able to pivot, in a clockwise direction or, conversely, in a counter-clockwise direction, about an axis of rotation oriented in the direction Y.

To this end, the device 10 preferably comprises at least one actuator 40 configured to drive said transmission system 20. The actuator comprises a drive shaft 41, able to rotate about the axis of rotation of said pinions 21. The actuator 40 further comprises a hydraulic or pneumatic cylinder or, more generally, any drive member able to cause a rotational movement of the drive shaft 41. The drive shaft 41 is connected to the pinions 21. Preferably, the drive member of the actuator 40 is situated outside the frame 50.

Preferably, said drive shaft 41 is a cylindrical rod extending between two lateral uprights of the frame 50, along the dashed line PF-PF. Preferably, an inner border of the pinions 21 conforms to the shape of the drive shaft 41, that is, said inner border follows the contour of the drive shaft 41 so that said pinions 21 can be guided in rotation by the drive shaft 41. The drive shaft 41 is articulated on bearings 44, which are connected to the frame 50.

The transmission system 20 further comprises two toothed rods 22 substantially parallel to the direction Z. As can best be seen in FIG. 1, each toothed rod 22 has teeth 22a and a flat border 22b. Said toothed rods 22 mesh in pairs with said pinions 21 by means of their respective teeth 22a. In other words, the teeth 22a of the toothed rods 22 conform exactly to the shape of the teeth 21b of the pinions 21. The toothed rods 22 are situated on either side of the pinions 21 in the direction X. Thus, in FIG. 2, first toothed rods 22, the teeth 22a of which can be seen at a position Pt2, are connected to a first curtain 11 situated below the dashed line PF-PF, while second toothed rods 22, the flat border of which 22b can be seen at a position Pt1, are connected to a second curtain 11 situated above the dashed line PF-PF.

When the pinions 21 turn, the toothed rods 22, the teeth 22a of which can be seen at position Pt2, slide in the direction of the upper beam of the frame 50, that is, to position Pt1, while at the same time, the toothed rods 22 the flat borders 22b of which can be seen at position Pt1 slide in the direction of the lower beam of the frame 50, that is, position Pt2. The toothed rods 22 associated with the same pinion 21 are therefore able to effect translational movements that are symmetrically opposed in the direction Z

Advantageously, the pinions 21 and a corresponding pair of toothed rods 22 are situated symmetrically on each side of said curtains 11. In this configuration, when the actuator 40 is in operation, the transmission system 20 is capable of driving the drive members 30, to which it is connected, while keeping said drive members horizontal relative to the direction Y.

As mentioned previously, the device 10 further comprises at least two drive members 30. Their features and operation are described below.

In general, said drive members 30 are connected to the transmission system 20. More specifically, here, each drive member 30 is connected to one of said toothed rods 22, so that any sliding of said toothed rods 22 in the direction Z leads to a translational movement of said drive members 30 in the same direction.

In such a configuration, as the transmission system 20 is “toothed”, by means of the pinion 21 and the corresponding toothed rods 22, it makes it possible to limit slip when the actuator 40 is in operation. The transmission system 20 therefore makes it possible to maintain a constant speed at which the drive members 30 are driven. This further makes it possible to transmit the forces efficiently. For example, a toothed rod 22 the teeth 22a of which move from position PT1 to position PT2, causes an equivalent movement of the drive member 30 to which it is connected from a distal position close to the winding/unwinding shaft 53 to a proximal position close to the drive shaft 41.

Preferably, the drive members 30 are rigid drive bars. Said drive bars connect said toothed rods 22 together in pairs and are able to be guided in translation by said toothed rods 22. Said drive bars are directly connected to said curtains 11, so that any translational movement of said drive bar in the direction Z causes a translational movement of said curtain 11 in the same direction. Said drive bars can be rigidly connected to the curtains 11. Alternatively, said drive bars can be flexibly connected to the curtains 11. In addition, because the drive members 30 are kept horizontal by the presence of a pinion 21 and the corresponding rods 22 on each side of the curtains 11, the borders 11a are therefore kept horizontal. This also makes it possible to distribute the forces symmetrically on the drive members 30.

As can be seen more clearly in the example illustrated in FIG. 1, the toothed rod 22 situated in the upper part (on the left in the drawing) is straight, and the associated drive bar is attached to an upper end of said toothed rod 22. The toothed rod 22 situated in the lower part (on the right in the drawing) has an L-shaped configuration, the long arm of the L having the teeth and the short arm ending in the continuation of the other toothed rod 22. The drive bar associated with the L-shaped toothed rod 22 is situated at the free end of said short arm of the L, so that the two curtains 11 are substantially in the same plane.

As a variant, said drive members 30 can be studs connected fixedly to the transmission system 20 and to the curtains 11. The studs are provided on either side of each of the curtains 11, each proximal corner of the curtains 11 then being fixed to said studs.

The principle of closing the curtains 11 is as follows.

When the actuator 40 is activated, the pinions 21 effect a rotational movement about their axis of rotation. This rotational movement of the pinions 21 causes a translational movement of the toothed rods 22 which are respectively associated with them, in the direction Z. As illustrated in FIG. 3, said toothed rods 22, the teeth 22a of which are initially situated in a position Pt2, move from the position Pt2 to the position Pt1, and, conversely, the toothed rods 22 the flat borders 22b of which are initially situated in position Pt1, move from said position Pt1 to position Pt2.

Incidentally, the drive members 30 connected to said toothed rods 22 are simultaneously guided in translation in opposite directions and drive the curtains 11 in their movement. As they move, the drive members 30 guide said curtains 11 so that their proximal borders 11a, initially situated in positions PO1 and PO2, reach the closed position PF and are in contact with each other.

Because the two pinions 21 are driven simultaneously by the drive shaft 41, the curtains 11 are guided symmetrically with respect to one another as they move. The distance separating the two curtains 11, in particular the proximal borders 11a thereof, remains equal on either side of the dashed line PF-PF, throughout their movement. When the curtains 11 are in contact, they do not let through the air flow F circulating perpendicular to the plane of extension of the curtains 11 in the closed position.

Conversely, the curtains 11 are able to return to their original position (as illustrated in FIG. 2) by moving in the direction of opening/closing Z, for example when the actuator 40 is no longer in operation. Because the curtain tensioning members 54 continuously exert a force on the curtains 11, said curtains 11 wind around their respective winding/unwinding shaft 53 again and the elements of said transmission system 20 and the drive members 30 return to their original position.

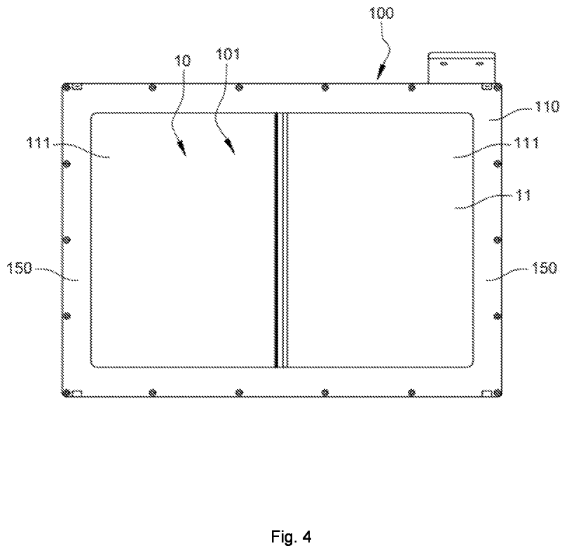

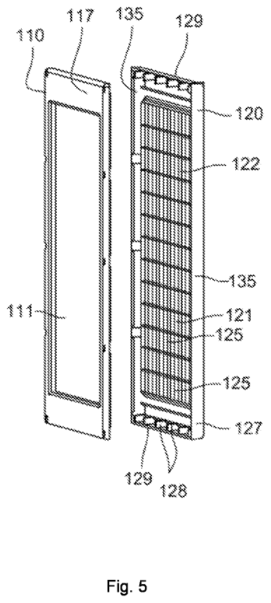

The device 10 described above can be placed in a frame 100 as described in FIGS. 4 and 5.

This frame 100 forms an inner space 101 inside which the curtains 11 are placed, the frame 100 including a front portion 110 and a rear portion 120 assembled with each other, the front portion 110 being upstream of the rear portion 120 in the direction of the air flow.

The front 110 and rear 120 portions include air passages 111 and 121 to let the air flow through when the two curtain 11 are in the open position.

The rear portion 120 includes a planar grille zone 122, which forms the air passage 121.

The rear portion 120 of the frame includes the grille zone 122 and the curtains 11 are arranged so that they can rest on this grille zone 122 when the curtains 11 are in the closed position.

The grille zone 122, which is substantially rectangular, is made up of bars 125 that intersect each other perpendicularly. The grille zone 122 includes for example a group of bars 125 parallel to each other and another group of bars 125 parallel to each other, and the bars 125 of the two groups intersect each other at right angles.

The rear portion 120 includes a peripheral border 127 surrounding the grille zone 122. This border 127 includes reinforcing ribs 128, for example on the two parallel sides 129 of said border 127.

The grille zone 122 is integrally formed and does not have any uprights passing through it, other than the bars 125 forming the grille.

The border 127 of the rear portion includes walls 135 perpendicular to the grille zone 122.

The front portion 110 of the frame 100 includes a completely free opening 111, facing the grille zone 122 of the rear portion 120, in particular having substantially the same surface area as said grille zone 122.

The front portion 110 can include a protective grille, in particular an anti-projectile grille, placed in the air passage.

The front portion 110 of the frame includes a border 117 surrounding the opening 111, this border 117 being arranged to interact with the border 127 of the rear portion 120, these borders 117, 127 being assembled by fastening members such as screws, snap-fitting members, or adhesive.

The front 110 and rear 120 portions of the frame are formed by molding a plastic material.

The curtains 11, once wound on themselves, each occupy a cylindrical space that runs along one side 150 of the borders of the front and rear portions 110, 120, while being inside the space delimited by the frame 100.

An electric actuator 40 is provided in order to actuate, that is, wind or unwind, the curtains(s) 11. Here, this actuator 40 is placed outside the frame 100.

Of course, the frame 100 can be adapted for other types of curtain 11 and/or curtain actuating mechanism.

Here, the curtains 11 are each in the form of a piece of cloth that can be wound around an axis.

Of course, the device 10 can have two curtains 11 that can be activated in a synchronized manner, or as a variant, it can have a single curtain 11 that occupies the entire opening when in the closed position.

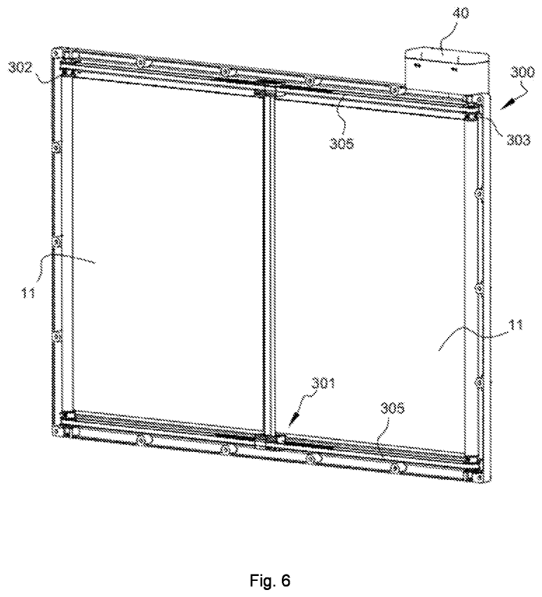

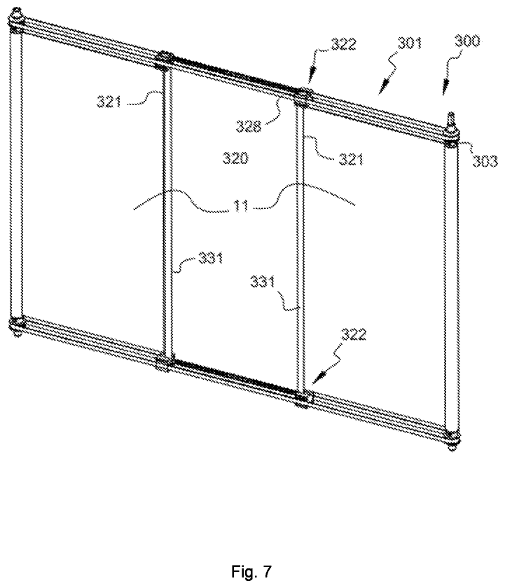

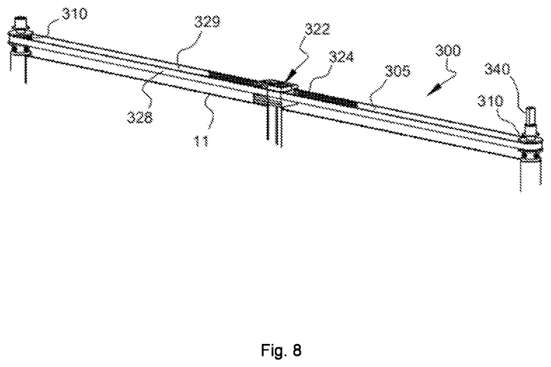

FIGS. 6 to 8 show an air flow device 300 according to another exemplary embodiment of the invention, the device 300 comprising two curtains 11 able to move in an opening/closing direction, between a closed position obstructing the passage of the air flow and an open position letting through the air flow, this device 300 including a transmission system 301 arranged to guide the movement of said curtains 11, together with an actuator 40 causing the transmission system to move, this transmission system 301 including two winding shafts 302 and 303, each for winding and unwinding one of the curtains 11, this transmission system 301 further including at least one belt 305 the movement of which can be actuated, arranged to rotate at least one of the winding shafts 302, 303 both in the winding direction of the curtain 11 and in the unwinding direction of the curtain 11.

The actuator 40 is arranged to rotate one of the winding shafts 302, 303, denoted 303 in the figures, selectively in an winding direction of the curtain 11 or in an unwinding direction of the curtain 11.

Each winding shaft 302 and 303 includes a toothed pinion 310 arranged to interact with the belt 305, which is notched so that the movement of the winding shaft 303, which movement is caused by the actuator 40, is transmitted to the other winding shaft 302.

The device 300 includes two belts 305, each at one end of the two winding shafts 302 and 303, so that each belt 305 is associated with two toothed pinions 310 of the two winding shafts 302, 303, these two belts 305 being arranged so that their movement is synchronized.

The device 300 includes a drive member 320 rigidly connected to a free edge 321 of the curtain 11 and arranged to move at the same time as the two belts 305 in order to accompany the curtain 11 when it is winding or unwinding, so as to keep the curtain 11 flat.

Each drive member 320 includes two carriages 322 arranged to be fastened to the two belts 305 so that the drive member 320 is rigidly connected to the two belts 305.

Each carriage 322 is clipped onto the associated belt 305, specifically clipped onto a strip 324 forming the belt.

For each belt, the carriage 322 associated with one of the curtains 11 is fastened to a first strand 328 of the belt between the two winding shafts 302 and 303 and the other carriage 322 associated with the other curtain 11 is fastened to a second strand 329 of the belt 305, opposite the first strand 328, so that the two carriages 322 can be moved in opposite directions, either moving away from each other or moving toward each other.

Each drive member 320 includes a rod 331 with one of the carriages 322 at each end of the rod 331, the rod 331 being placed along a free edge 321 of the associated curtain 11. In particular, when the two curtains 11 are in the closed position, the two rods 331 rest against each other. The carriages 322 are in particular fastened to the belt 305 without any possible relative movement in relation to said belt 305.

The carriages 322 are made from plastic.

In order to open or close the curtain 11, the curtain 11 is thus driven both by the winding shaft 302 and by the drive member 320, at the two ends. The simultaneous action at the two ends of the curtain 11 makes it possible to keep the curtain 11 taut as desired, thus preventing creases or folds and the potential trapping of the curtain 11.

According to one aspect of the invention, the direction for winding the curtain 11 around the winding shaft 302, 303 is the same on both winding shafts 302, 303. This is made possible due to the curtains 11 being wound the opposite way on the two winding shafts 302, 303.

The belts 305 thus make possible the rotation of one of the winding shafts 302, 303 at the same time as the translational movement of the drive member 320 of the curtain 11 via the carriages 322.

The winding shaft 303 interacts with the actuator 40 via an interacting stud 340.

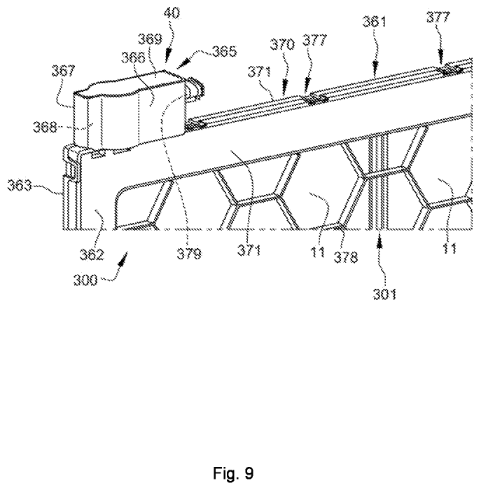

FIG. 9 shows an example of an electric actuator 40, as described with reference to FIG. 6.

The device 300 includes a frame 361 for housing the curtains 11.

This frame 361 includes a front portion 362 and a rear portion 363, the front portion 362 being placed upstream of the rear portion 363 in the direction of the air flow, this frame 361 including a housing 365 associated with the actuator 40.

This housing 365 receives in particular an electric motor, not visible in the figures, of the actuator 40, this housing 365 including a housing portion 366 integrally formed with the front portion 362 of the frame 361 and another housing portion 367 formed with the rear portion 363 of the frame 361.

The two housing portions 366 and 367 are sealably assembled, with a seal inserted between these housing portions.

The housing portions 366 and 367 form a recess 368 for the electric motor and at least one of the housing portions 366 or 367 includes a cap 369 closing this recess 368, this cap 369 and the associated housing portion 366 being integrally formed.

The cap 369 of the housing 365 is flat.

The frame 361 includes a border 370 and the housing 365 of the actuator is placed on this border 370.

The housing portions 366 and 367 are respectively formed with a bar 371 of the front or rear portion of the frame 361, these bars 371 together forming the border 370 of the frame 361 that is in contact with the housing 365 of the actuator.

The housing 365 extends over less than half of the length of the bars 371, in particular less than one third, or even one quarter, of this length.

An orifice 372 is provided in the bottom of the housing 365 for a gear element to pass through for example, to the curtains 11.

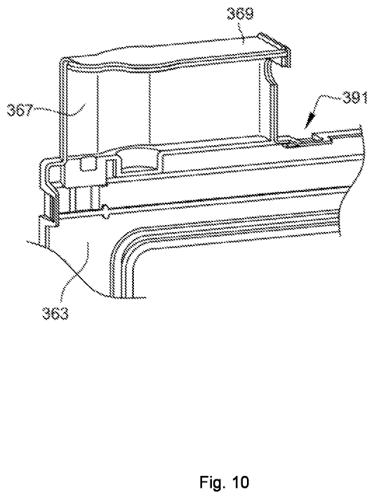

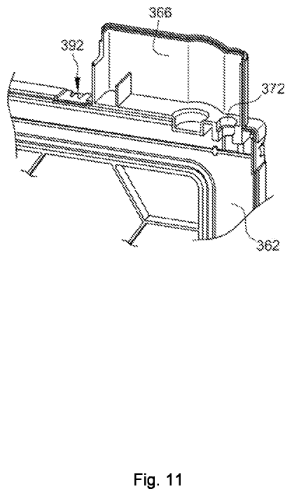

The actuator housing portions 366 and 367 are formed by molding or co-molding with the respective front and rear portions 362 and 363 of the frame 361, as can be seen more clearly in FIGS. 10 and 11.

The front and rear portions 362 and 363 of the frame 361 are assembled with snap-fitting elements 391 and 392 forming a pair 377 of snap-fitting elements 391, 392.

At least one of the front and rear portions 362 and 363 of the frame 361 includes a mesh 378, in particular honeycomb shaped, produced in particular by molding with this frame portion 362, 363.

The actuator housing 365 includes at least one orifice 379 for an electrical connection element to pass through, in particular for the actuator motor.

The two housing portions 366 and 367 are sealably assembled, in particular with a seal inserted between these housing portions 366, 367.

The snap-fitting element 391 includes a deformable snap-fitting tab arranged to interact with the other snap-fitting element 392.

The snap-fitting tab 391 includes an opening for interacting with the other snap-fitting element 392, which includes a protrusion.

The frame 361 includes a plurality of pairs of snap-fitting elements 391 and 392 distributed on the four sides of the perimeter of the frame 361.

The frame 361 includes a border 370 and the actuator housing 365 is placed on this border 370.

The snap-fitting elements 391, 392 have smaller dimensions than the border 370 so that the snap-fitting elements 391, 392 remain within a width of this border 370.

The snap-fitting elements 391, 392 are integrally formed with the respective frame portions 362, 363.

The front and rear portions 362, 363 of the frame 361 are thus assembled without the use of screws or bolts.

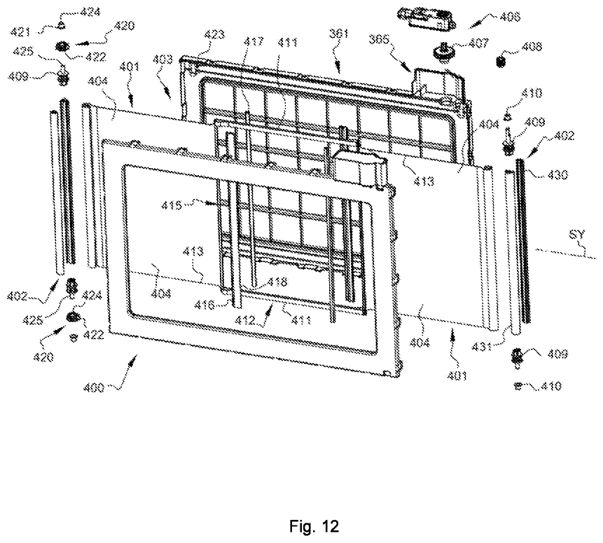

FIGS. 12 to 16 show an exemplary embodiment of the invention.

The parts of the air flow regulating device 400 are not described in detail when they are present in the preceding exemplary embodiments. The same reference signs are used for the same parts.

FIG. 12 shows a device 400 for regulating an air flow intended to circulate through a heat exchanger for a motor vehicle, the device 400 comprising two curtains 401 each able to move in an opening and closing direction, between a closed position obstructing the passage of the air flow and an open position allowing through the air flow (F), each curtain 401 being arranged to wind and unwind around a winding shaft 402, the device including a kinematic assembly 403 arranged to set each curtain 401 in motion in the opening and closing direction, said kinematic assembly 403 including at least one portion 404 of the curtain 401. Here, the portion 404 is the entire curtain 401. Each curtain 401 is thus a link in the kinematic assembly 403.

In the described example, the device 400 includes two winding shafts 402, positioned at two longitudinal ends of an air passage 405, and each curtain 401 is arranged so that it can wind around the corresponding shaft 402, the kinematic assembly 403 interacting with the two shafts 402.

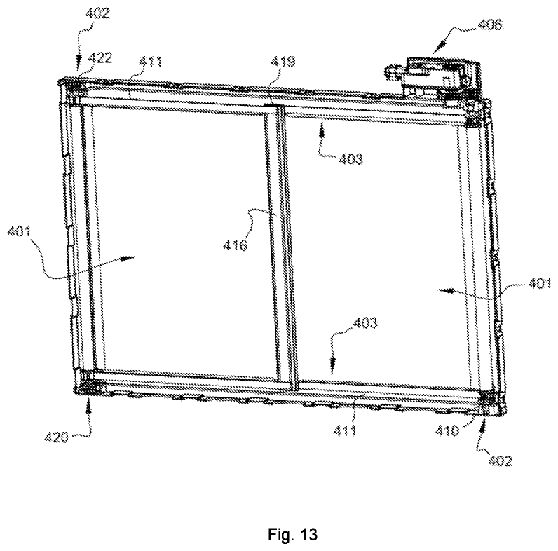

The device 400 includes an electric actuator 406 interacting with one of the winding shafts 402 in order to rotate it via two toothed wheels 407 and 408, visible in FIGS. 12 and 13 in particular, and the kinematic assembly 403 is arranged to be set in motion by this winding shaft 402, which is driven by the electric actuator 406.

The toothed wheel 407 is rigidly connected to the actuator 406, to the electric motor thereof in particular, and the toothed wheel 408 is rigidly connected to the winding shaft 402. These wheels 407 and 408 mesh with each other.

Each winding haft 402 includes end pieces 409 at its longitudinal ends, interacting with bearings 410.

The kinematic assembly 403 is arranged to transmit a movement of the winding shaft 402 associated with the electric actuator 406 to the other winding shaft 402, said kinematic assembly 403 thus interacting with the two winding shafts 402 in order to associate the respective rotation thereof.

One of the winding shafts 402 can be driven by the electric actuator and the other winding shaft 402 is passive, being driven by the kinematic assembly 403, which transmits the movement of the winding shaft 402 associated with the actuator 406 to the other winding shaft 402.

Each curtain 401 is extended by a belt element 411 that forms part of the kinematic assembly 403.

The belt element 411 is integrally formed with the curtain 401, that is, the curtain 401 and said belt element 411 are made in one piece 412, said piece 412 being in particular a piece of cloth.

This piece 412 is obtained by cutting.

The belt element 411 that extends the curtain 401 forms a complete belt with the curtain 401, connecting the two winding shafts for 402 conjoint movement. In other words, the curtain 401 itself plays a role in the transmission of movement from one winding shaft 402 to the other.

This cloth of the piece 412 is made from a flexible material, in particular a glass fiber-based cloth covered with an impermeable, water-repellent coating.

In the example described, each curtain 401 is extended by two belt elements 411 parallel to each other, on two opposite edges of the curtain 401, these belt elements 411 forming part of the kinematic chain 403.

Said belt elements 411 are symmetrical to each other about a line of symmetry SY passing through the middle of the curtain 401.

Each belt element 411 has an elongate shape.

The belt element 411 is substantially the same length as the curtain 401 measured along the opening and closing direction of the curtain 401, parallel to the axis of symmetry SY.

Each curtain 401 is extended by a belt element 411, which in particular takes the form of a strip of material, and the curtain 401 has lower and upper edges 413, parallel to the opening and closing direction of the curtain 401, the belt element extending parallel to said edges of the curtain 401.

One of the belt elements 411 extends at least partially above the upper edge 413 of the curtain 401 and the other belt element 411 extends at least partially below the lower edge 413 of the curtain 401.

In other words, when the curtain 401 and the belt elements 411 are laid flat, the belt elements 411, in particular formed from strips of material, move away from the upper and lower edges 413 of the curtain 401. The belt elements 411 thus do not obstruct the air flow passage 405 when the curtain 401 is open, and are away from the location occupied by the curtain 401 in the closed position.

The device 400 includes two identical curtains 401, each with a pair of belt elements 411 positioned parallel to the lower and upper edges 413 of the curtain 401.

Each curtain 401 includes a straight leading border 415 perpendicular to the opening and closing direction of the curtain 401, the upper and lower edges 413 being perpendicular to the leading border 415.

The belt elements 411 are connected to the curtain 401 level with the leading border 415.

The leading border 415 is rigidly connected to a sealing member 416, in the form of a rod 417 assembled with a seal 418.

The seal 418, which has for example a sealing lip 419, is fastened to said rod 417.

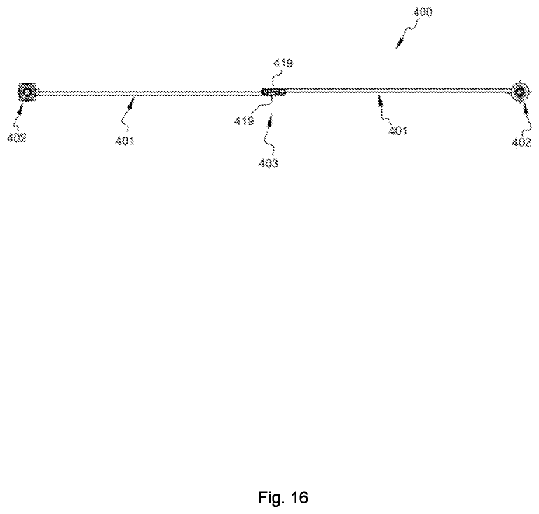

As can be seen in particular in FIG. 16, the sealing lips 419 associated with the two curtains 401 come into contact with each other when the curtains 401 are in the closed position, so that they prevent the air flow from passing through.

If two opposite 401 are provided, each curtain 401 is wound on a winding shaft 402 and the belt elements 411 associated with said curtain 401 wind on the other winding shaft 402.

On each winding shaft 402, the curtain 401 that winds on it occupies the majority of the height of said shaft 402 and, at the ends of the winding shaft 402, outside this portion occupied by the curtain 401, are two zones 409 for fastening the belt elements 411 of the other curtain 401, which curtain 401 is wound on the opposite winding shaft 402. The zones for fastening the belt elements 411 are on the end pieces 409.

The end of each belt element 411 is fastened to a core 409, in particular made from plastic, said core 408 forming part of the winding shaft 402. This core 408 is on the end piece 409.

The belt elements 411 form straps that extend the curtain 401. The curtain portion that forms part of the kinematic assembly 403 is thus the entire curtain 401.

The winding shaft 402 that is not directly driven by the electric actuator 406 is rigidly connected to a tensioning unit 420 including an elastic member, here a spring housed in a body 421, arranged to move the winding shaft 402 over a sufficient translation amplitude to keep the curtain(s) 401 tensioned.

This tensioning unit 420 includes a retractable spur 422 acting against the spring, in order to move said unit 420. The spur rests against a stop 423. The tensioning unit 420 can thus be moved relative to said stop 423, which forms part of the frame 361 similar to the frame 361 described in the preceding example. Said frame 361 is not described in further detail here.

Two tensioning units 420 are provided on the passive shaft 402, joined to the end pieces 409.

Each tensioning unit 420 includes a fastening element provided with an orifice 424 through which can pass a protrusion, here a spur 425, of the winding shaft 402, more specifically of the end piece 409, in order to rigidly connect said shaft 402 and the tensioning unit 420 for conjoint translation.

Said unit 420 can move relative to the fixed wall, here the stop 423, against the elastic force of the spring, so that the spacing between the two winding shafts 402 can vary and maintain sufficient tension in the curtain(s) 401.

The winding shaft 402 includes two assembled longitudinal portions 430 and 431 around which the curtain 401 winds.

When two curtains 401 are provided, they extend, in the closed position, substantially in two parallel planes, which planes are spaced apart from each other by a certain non-zero distance, in particular less than 5 mm, or 1 mm. In other words, in the closed position, the two curtains 401 do not extend exactly in the same plane, as can be seen in FIG. 16.

When a single curtain 401 is provided for closing the air passage, the belt elements 411 are substantially twice the length of the curtain 401, these dimensions being measured along the closing and opening direction of the curtains 401.

In one variant, the belt elements 411 are elements assembled with the associated curtain 401, that is, the belt element 411 is not integrally formed with the curtain 401.

The belt element 411 is for example made from a different material from the curtain 401, and if applicable is fastened to the curtain 401 using a fastening, for example stitching, adhesive, welding, etc.

Of course, the upper and lower edges of the curtain 401 can be vertical right and left edges if the curtain(s) 401 is/are used in vertical movement, with the closing direction oriented vertically instead of horizontally.

As in the preceding example, the frame 361 includes a housing 365 for accommodating the actuator 406.

The frame 361 includes a gridded mesh 437 to protect the curtains 401.

FIG. 13 shows the curtains 401 in the closed position, the seals 418 sealably closing the contact between the curtains 401.

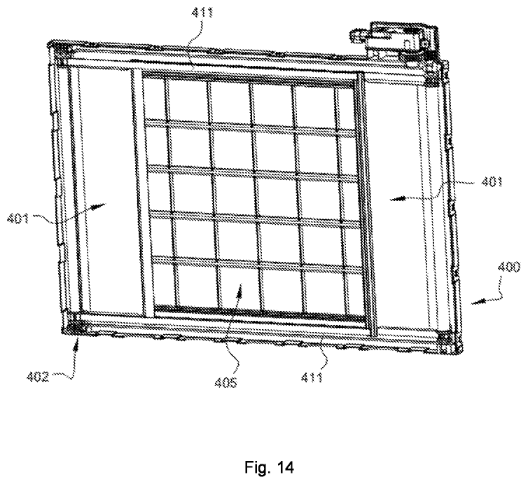

FIG. 14 shows the curtains 401 partially open.

To move from the closed position to a more open position, the kinematic assembly 403, via the belt elements 411 and the curtains 401, acts like a belt in order to rotate the winding shafts 402 in a synchronized manner.

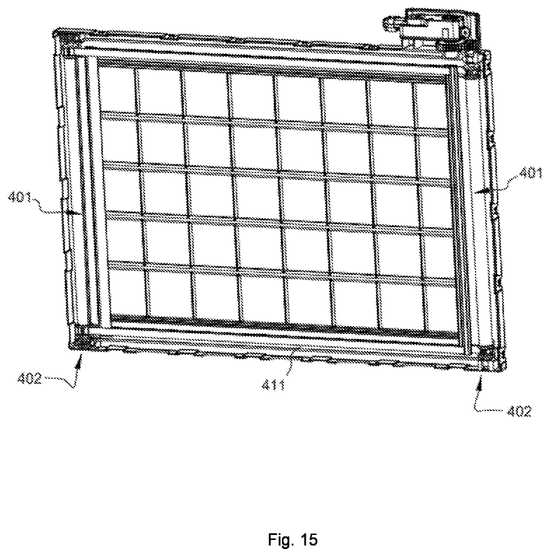

FIG. 15 shows the curtains 401 in the fully open position. The belt elements 411 that extend the curtains 401 can be seen.

What is claimed is:

1. A device for regulating an air flow intended to circulate through a heat exchanger for a motor vehicle, the device comprising at least one curtain able to move in an opening and closing directions, between a closed position obstructing the passage of the air flow and an open position allowing through the air flow, the at least one curtain being arranged to wind and unwind around a first winding shaft, the device including a kinematic assembly arranged to set the at least one curtain in motion in the opening and closing direction, said kinematic assembly including at least one portion of the curtain.

2. The device according to claim 1, in which the device a second winding shaft, so that the first and second winding shafts are respectively positioned at two longitudinal ends of an air passage, and the curtain is arranged so that it can wind around at least one of the first and second winding shafts, the kinematic assembly interacting with the first and second winding shafts.

3. The device as claimed in claim 1, in which the at least one curtain is extended by a belt element that forms part of the kinematic assembly.

4. The device as claimed in claim 3, in which the belt element is integrally formed with the at least one curtain.

5. The device as claimed in claim 4, in which said piece is obtained by cutting.

6. The device as claimed in claim 5, in which the at least one curtain is extended by two belt elements, on two opposite edges of the curtain, said two belt elements forming part of the kinematic chain.

7. The device as claimed in claim 1, in which the device includes two identical curtains, each with a pair of belt elements positioned respectively parallel to lower and upper edges of the curtain.

8. The device as claimed in claim 1, in which the at least one curtain includes a leading border perpendicular to the opening and closing directions of the at least one curtain.

9. The device as claimed in claim 8, in which the leading border is rigidly connected to a sealing member.

10. The device as claimed in claim 2, in which at least one of the winding shafts is rigidly connected to a tensioning unit including an elastic member arranged to move the at least one of the winding shafts over a sufficient translation amplitude to keep the at least one curtain tensioned.
